(19) United States
(12) Patent Application Publication
(10) Pub. No.: US 2005/0079029 A1
(43) Pub. Date: Apr. 14, 2005

(54) Notch tension reduction by adapted thread pitch in screw connections

(76) Inventors: Christian Braeuer, Steyr (AT); Stefan Holl, Dresden (DE)

Correspondence Address: RONALD E. GREIGG;GREIGG & GREIGG P.L.L.C., Suite One, 1423 Powhatan Street, Alexandria, VA, 22314, US

(21) Appl. No.: 10/928,108

(22) Filed: Aug. 30, 2004

(30) Foreign Application Priority Data
Aug. 28, 2003 (DE) 1 03 39 643.8

(51) Int. Cl. F16B 35/00

(52) U.S. Cl. 411/308

(57) ABSTRACT

Screw elements used in screw connections are embodied in such a way that the incident notch tensions are distributed as uniformly as possible over the entire length of the screw. One of the screw elements involved in the screw connection has a thread pitch (G1) which over at least a portion of the screw fastening length differs from the thread pitch (G2) in the remainder of the screw fastening length.

### BACKGROUND OF THE INVENTION

1. Field of the Invention

The invention relates to screw elements of the type used in screw connections in which screws are used as fastening screws; that is, between the flanks of the screw elements involved, friction occurs, which causes self-locking and prevents loosening of the connection, and only by external action can the screw connection be undone again.

2. Description of the Prior Art

A screw connection as a rule comprises a screw, a nut, the parts to be clamped, and accessories such as shims. The frictional force that leads to the strength of the connection exists between the threaded faces of the screw and the nut. The threads are defined in their dimensions by standards and are listed with tolerances included. In particular, the values for the thread pitch, that is, the distance between adjacent thread peaks, are the same for the screw and the nut.

In the screwed-together state, in which a deformation of the screw elements by force exists, the greatest tensile force acts on the screw in the region of the first thread courses, that is, the thread courses that are not screwed in as far as the others. The thread courses that are screwed in to a greater depth are not as severely affected by the tensile stress.

The difference in the tensions with respect to the thread depth is known to be so great that practically all the tension is present in the first two thread courses, so that the remaining thread courses are hardly loaded at all. For instance, it can happen that 70% of the screwing force is absorbed by the first thread course, a further 20% by the second thread course, and the remaining 10% is distributed over the other thread courses.

Because of the difference between the outside diameter and the core diameter of the screw, the tension does not have a uniform course; instead, it is concentrated, in the form of notch tensions.

In certain regions of the screw elements, peak tensions can therefore occur, which impair the stability of a screw connection and can even cause screw breakage. This problem arises particularly in dynamic loading of the screw connection, for instance in the event of pulsation or vibration.

### OBJECT AND DESCRIPTION OF THE INVENTION

The object of the invention is to embody screw elements in such a way that the notch tensions are distributed as uniformly as possible over the entire screw length.

This object is attained in that at least one of the screw elements involved in the screw connection has a thread pitch which over at least a portion of the screw fastening length differs from the thread pitch in the remainder of the screw fastening length.

By means of an adaptation of the thread pitch over the screw fastening length, the incident notch tension can be distributed uniformly over all the thread courses involved in the screwing action.

In principle, the thread pitches of screw elements involved in a screw connection must fit one another, and as a rule, the thread pitch is constant over the screw length. It is therefore favorable if the thread pitch of the screw element of the invention has a course over the screw fastening length in which it approaches a constant value. Preferably, the course of the thread pitch of the screw element over the screw fastening length is a monotonous function.

In screwing the screw elements, unnecessary tensions which under some circumstances could cause damage to the thread courses should be averted. Advantageously, the maximum difference of the thread pitch of the screw element is therefore within the tolerance of the counterpart over the screw fastening length.

The thread pitches can be adapted in such a way that all the screw elements involved in the screw connection have thread pitches that are not constant; however, it also suffices if one screw element has an adapted thread pitch, while its counterpart has a constant thread pitch over the screw fastening length.

If the screw element of the invention is a screw which cooperates with a nut that has a constant thread pitch, then the thread pitch in the region of the first thread courses should be reduced, in order to compensate for the deformation from the higher tensile stress operative there and to distribute the notch tension uniformly over all the thread courses.

Because of the somewhat lesser thread pitch, the screw in the nut can adapt optimally even upon elongation loading, without peak tensions arising. The screw connection can as a result exploit a maximum elongation length, which is favorable particularly with a view to the prestressing losses that occur over the service life of the screw connection.

The adaptation of the thread pitch can be done with cylindrical threads, but also with screw connections that have a partially or entirely conical thread, in which the outside and core diameters of the screw are accordingly not constant over the entire screw length. The variation in the outer and core diameters over the screw length can even lead to a further reduction in tension.

### BRIEF DESCRIPTION OF THE DRAWING

The invention will be better understood and further objects and advantages thereof will become more apparent from the ensuing detailed description of a preferred embodiment taken in conjunction with the drawing, in which the single drawing FIGURE schematically shows a section through a screw connection with a screw element.

### DESCRIPTION OF THE PREFERRED EMBODIMENT

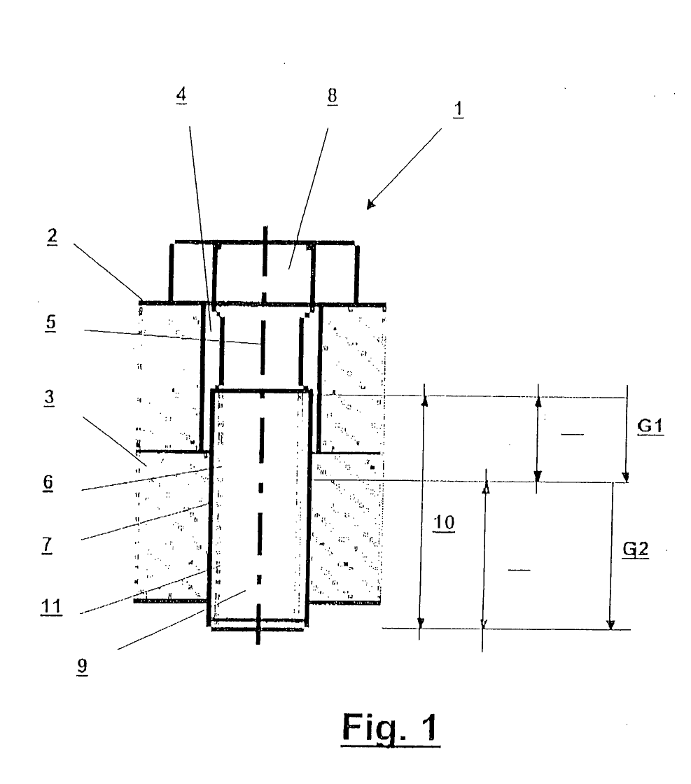

In FIG. 1, one exemplary embodiment of the invention is shown in which a screw is provided in order to join two plate elements 2, 3 to one another in a way that can be undone again. To that end, the first plate element 2 has a through bore 4 with a center axis 5, and the further plate element 3 has, on the same center axis 5, a threaded bore 6 with a thread 7. The screw element 1 itself has a screw head 8 and a shank 9 with a screw fastening length 10. The screw fastening length 10 is determined by the thread 11 of the screw element 1. According to the invention, at least two regions 12, 13 of the thread 11 in which the thread 11 has different thread pitches G1 and G2 are now provided.

Preferably, the first region 12, which is oriented toward the screw head 8 and which involves the first thread courses, which in the plate element 3 cooperate with the threaded bore 6, or the thread 7 disposed in the threaded bore 6, is provided with a thread pitch G1 that is less, compared to the further region 13.

Preferably, the thread pitches G1 and G2 of the regions 12 and 13 are designed such that they ascend monotonously.

The thread 7 in the threaded bore 6 has a constant thread pitch G2 over the entire screw fastening length 10 of the screw element 1, and the thread pitches G1 and G2 are designed such that because of the existing tolerances, the screw element 1 can be screwed into the threaded bore 6.

Because of this design, it is possible in a very simple way to distribute the notch tension, which is operative inside the screw element 1 when it has been screwed, uniformly over the screw fastening length 10 of the screw element 1.

The foregoing relates to a preferred exemplary embodiment of the invention, it being understood that other variants and embodiments thereof are possible within the spirit and scope of the invention, the latter being defined by the appended claims.

1. A screw element for producing a screw connection,
the screw element (1) comprising a threaded portion having a thread pitch (G1) which, over at least a portion of the screw fastening length (10), differs from the thread pitch (G2) in the remaining portion of the screw fastening length (10).

2. The screw element of claim 1, wherein
the thread pitch (G1, G2) of the screw element (1) has a course over the screw fastening length (10) in which the thread pitch approaches a constant value.

3. The screw element of claim 1, wherein
the course of the thread pitch (G1, G2) of the screw element (1) over the screw fastening length (10) is a monotonous function.

4. The screw element of claim 2, wherein
the course of the thread pitch (G1, G2) of the screw element (1) over the screw fastening length (10) is a monotonous function.

5. The screw element of claim 1, wherein
the maximum difference in the thread pitch (G1, G2) of the screw element (1) over the screw fastening length (10) is within the tolerance of the counterpart element.

6. The screw element of claim 2, wherein
the maximum difference in the thread pitch (G1, G2) of the screw element (1) over the screw fastening length (10) is within the tolerance of the counterpart element.

7. The screw element of claim 3, wherein
the maximum difference in the thread pitch (G1, G2) of the screw element (1) over the screw fastening length (10) is within the tolerance of the counterpart element.

8. The screw element claim 1, wherein
the screw element (1) is a screw which cooperates with a nut having a constant thread pitch.

9. The screw element claim 2, wherein
the screw element (1) is a screw which cooperates with a nut having a constant thread pitch.

10. The screw element claim 3, wherein
the screw element (1) is a screw which cooperates with a nut having a constant thread pitch.

11. The screw element claim 5, wherein
the screw element (1) is a screw which cooperates with a nut having a constant thread pitch.

12. The screw element of claim 1, wherein
the screw element (1) is a screw whose thread pitch has a lesser thread pitch (G1) in the region of the first thread courses than in the remaining screw fastening region.

13. The screw element of claim 2, wherein
the screw element (1) is a screw whose thread pitch has a lesser thread pitch (G1) in the region of the first thread courses than in the remaining screw fastening region.

14. The screw element of claim 3, wherein
the screw element (1) is a screw whose thread pitch has a lesser thread pitch (G1) in the region of the first thread courses than in the remaining screw fastening region.

15. The screw element of claim 5, wherein
the screw element (1) is a screw whose thread pitch has a lesser thread pitch (G1) in the region of the first thread courses than in the remaining screw fastening region.

16. The screw element of claim 8, wherein
the screw element (1) is a screw whose thread pitch has a lesser thread pitch (G1) in the region of the first thread courses than in the remaining screw fastening region.

17. The screw element of claim 1, wherein
the screw element (1) is a nut which cooperates with a screw that has a constant thread pitch.

18. The screw element of claim 2, wherein
the screw element (1) is a nut which cooperates with a screw that has a constant thread pitch.

19. The screw element of claim 3, wherein
the screw element (1) is a nut which cooperates with a screw that has a constant thread pitch.

20. The screw element of claim 5, wherein
the screw element (1) is a nut which cooperates with a screw that has a constant thread pitch.
